(19) United States
(12) Patent Application Publication
(10) Pub. No.: US 2026/0164286 A1
(43) Pub. Date: Jun. 11, 2026

(54) AI-BASED CSI PREDICTION WITH TIMING-OFFSET AND FREQUENCY-OFFSET IMPAIRMENTS

(71) Applicant: Samsung Electronics Co., Ltd., Suwon-si (KR)

(72) Inventors: Tianyu Li, Saint-Lin-Laurentides (CA); Samuel Albert, Robbinsville, NJ (US); Yan Xin, Princeton, NJ (US); Jianzhong Zhang, Dallas, TX (US)

(21) Appl. No.: 19/383,435

(22) Filed: Nov. 7, 2025

Related U.S. Application Data
(60) Provisional application No. 63/725,982, filed on Nov. 27, 2024.

(51) Int. Cl. H04W 24/10; H04W 24/02

(52) U.S. Cl. CPC H04W 24/10; H04W 24/02

(57) ABSTRACT

A base station (BS) includes a transceiver configured to receive channel state information (CSI) from a user equipment (UE). The BS also includes a processor operably coupled to the transceiver. The processor is configured to obtain one or more input tensors in a frequency domain, the one or more input tensors associated with the CSI received from the UE. The processor is also configured to transition time interval (TTI)-wise normalize the one or more input tensors, delay-angle domain transform a result of the TTI-wise normalization, and generate a next time step CSI prediction for the UE based on a result of the delay-angle domain transformation.

### CROSS-REFERENCE TO RELATED APPLICATION(S) AND CLAIM OF PRIORITY

This application claims priority under 35 U.S.C. § 119 (e) to U.S. Provisional Patent Application No. 63/725,982 filed on Nov. 27, 2024. The above-identified provisional patent application is hereby incorporated by reference in its entirety.

### TECHNICAL FIELD

This disclosure relates generally to wireless networks. More specifically, this disclosure relates to artificial intelligence (AI)-based channel state information (CSI) prediction with timing-offset and frequency-offset impairments.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for AI-based CSI prediction with timing-offset and frequency-offset impairments.

In one embodiment, a base station (BS) is provided. The BS includes a transceiver configured to receive channel state information (CSI) from a user equipment (UE). The BS also includes a processor operably coupled to the transceiver. The processor is configured to obtain one or more input tensors in a frequency domain, the one or more input tensors associated with the CSI received from the UE. The processor is also configured to transition time interval (TTI)-wise normalize the one or more input tensors, delay-angle domain transform a result of the TTI-wise normalization, and generate a next time step CSI prediction for the UE based on a result of the delay-angle domain transformation.

In another embodiment, a method of operating a BS is provided. The method includes receiving CSI from a UE, and obtaining one or more input tensors in a frequency domain, the one or more input tensors associated with the CSI received from the UE. The method also includes TTI-wise normalizing the one or more input tensors, delay-angle domain transforming a result of the TTI-wise normalization, and generating a next time step CSI prediction for the UE based on a result of the delay-angle domain transformation.

In yet another embodiment, a non-transitory computer readable medium embodying a computer program. The computer program includes code that when executed by a processor of a device, causes the device to receive CSI from a UE, and obtain one or more input tensors in a frequency domain, the one or more input tensors associated with the CSI received from the UE. The computer program also includes code that, when executed by the processor of the device, causes the device to TTI-wise normalize the one or more input tensors, delay-angle domain transform a result of the TTI-wise normalization, and generate a next time step CSI prediction for the UE based on a result of the delay-angle domain transformation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example antenna beamforming architecture according to embodiments of the present disclosure;

FIG. 5 illustrates an example channel prediction pipeline according to embodiments of the present disclosure;

FIG. 6 illustrates an example data preprocessing pipeline according to embodiments of the present disclosure;

FIG. 7 illustrates an example ResNet model structure according to embodiments of the present disclosure;

FIG. 8 illustrates an example delay-angle domain truncation for reducing computation complexity of ML models according to embodiments of the present disclosure;

FIG. 9A illustrates an example structure of LSTM units according to embodiments of the present disclosure;

FIG. 9B illustrates an example structure of GRU units according to embodiments of the present disclosure;

FIG. 10 illustrates an example model framework for multiple layers of ConvRNN networks according to embodiments of the present disclosure;

FIG. 11 illustrates an example model framework for multiple layers of stacked ConvRNN networks according to embodiments of the present disclosure; and

FIG. 12 illustrates an example method for AI-based high-speed CSI prediction with timing-offset and frequency-offset impairments according to embodiments of the present disclosure.

### DETAILED DESCRIPTION

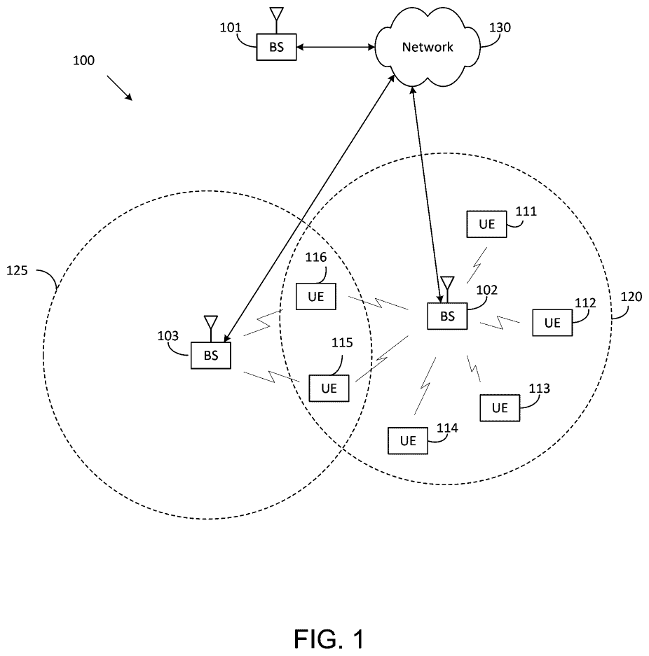

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for AI-based high-speed CSI prediction with timing-offset and frequency-offset impairments. In certain embodiments, one or more of the gNBs 101-103 includes circuitry, programing, or a combination thereof, to support AI-based high-speed CSI prediction with timing-offset and frequency-offset impairments in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

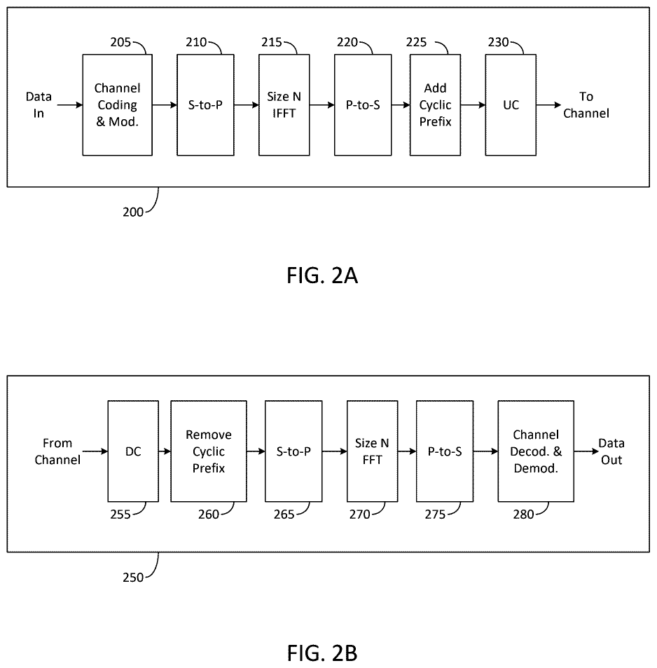

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support AI-based high-speed CSI prediction with timing-offset and frequency-offset impairments as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

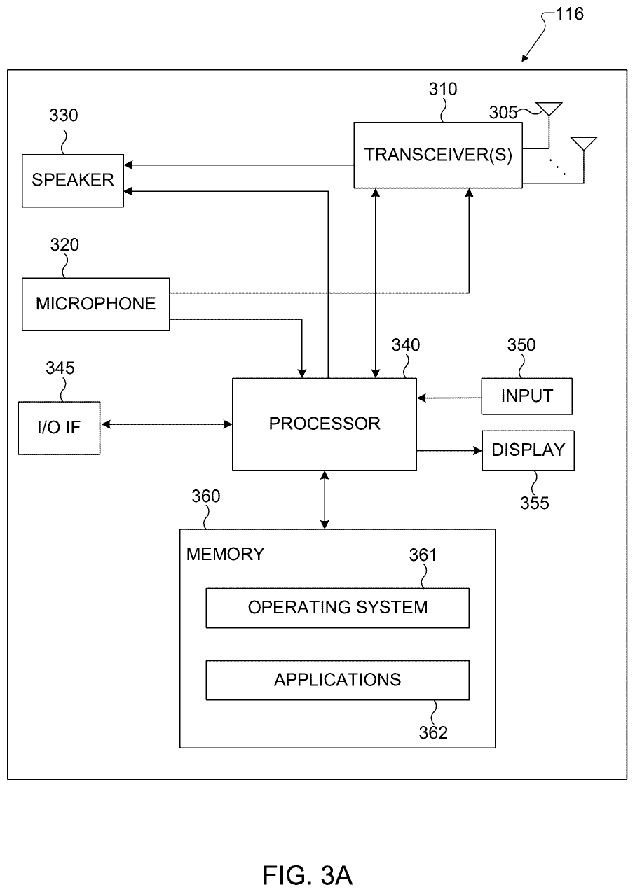

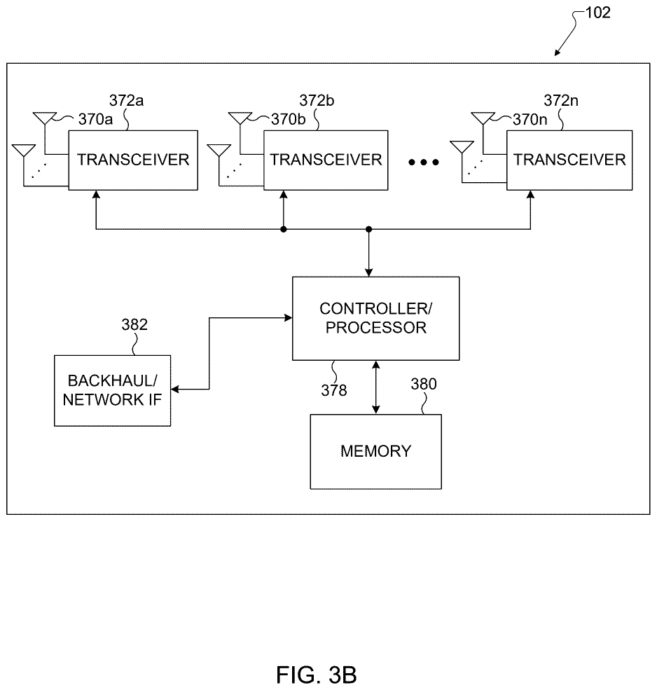

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for AI-based high-speed CSI prediction with timing-offset and frequency-offset impairments as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support AI-based high-speed CSI prediction with timing-offset and frequency-offset impairments as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

Rel.13 LTE supports up to 16 channel state information (CSI)-reference signal (RS) antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel. 14 LTE. For next generation cellular systems such as 5G, it is expected that the maximum number of CSI-RS ports will remain more or less the same.

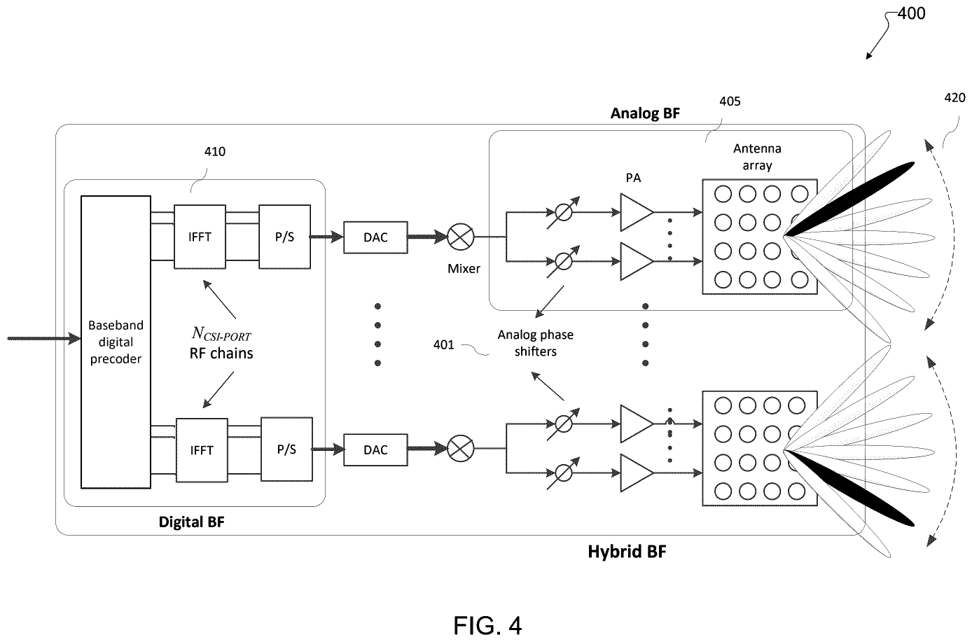

For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mm Wave frequencies) as illustrated by beamforming architecture 400 in FIG. 4.

FIG. 4 illustrates example antenna beamforming architecture 400 according to embodiments of the present disclosure. The embodiment of the antenna beamforming architecture illustrated in FIG. 4 is for illustration only. Different embodiments of an antenna beamforming architecture could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports NCSI-PORT. A digital beamforming unit 410 performs a linear combination across NCSI-PORT analog beams to further increase precoding gain. While analog beams are wideband (hence not frequency-selective), digital precoding can be varied across frequency sub-bands or resource blocks (RBs).

Although FIG. 4 illustrates one example antenna beamforming architecture 400, various changes may be made to FIG. 4. For example, various components in FIG. 4 could be combined, further subdivided, or omitted and additional components could be added according to particular needs.

Massive MIMO (mMIMO) is an important technology used to improve the spectral efficiency of 4G and 5G cellular networks that has been adopted in some massive MIMO units (MMUs). The number of antennas in mMIMO is typically much larger than the number of UEs, which allows the BS to perform multi-user DL beamforming to schedule parallel data transmissions on the same time-frequency resources. However, mMIMO performance depends heavily on the quality of CSI at the BS. It has been recently verified that multi-user (MU)-MIMO performance degrades with UE mobility. CSI prediction can be used to combat CSI aging, thus the system can reduce the impact of processing delay and possibly the overhead. Solutions for these problems are desirable, especially at higher UE mobility.

Data-driven (e.g., artificial intelligence [AI] based) approaches can be utilized for CSI prediction, allowing model flexibility and applicability to the environment of interest. Currently, AI based channel prediction is one of the study cases in 3GPP for Rel-18. However, high-speed CSI prediction poses significant difficulty for AI based approaches. Additionally, timing and frequency offset impairments, which are often present in CSI prediction problems, can be extremely detrimental to the learning process of AI methods. Various embodiments of the present disclosure provide methods and techniques for leveraging AI based approaches to tackle high-speed UEs' CSI prediction tasks under the effects of timing and frequency offset impairments. Various embodiments of the present disclosure also provide some corresponding signaling details for the disclosed methods. Furthermore, various embodiments of the present disclosure provide methods to enhance the training of various data-driven solutions disclosed herein.

In MIMO systems, CSI becomes stale quickly for UEs in highly dynamic environments. This is especially for mMIMO systems, in which the BS relies on a sounding reference signal sent by a UE in the network. The UE also relies on scheduled pilot transmissions (e.g., CSI-RS) by the BS. This greatly reduces the performance of mMIMO and MU-MIMO transmission with mobile UEs or within highly dynamic environments. Data driven approaches may solve these problems, as they can learn the channel complexity for in the environment of interest. However, some approaches can struggle with the complexity and non-linearity of modern communication environments that arise from high-speed mobility as well as timing and frequency offset impairments, therefore reaching suboptimal performance when incorporating into the current telecommunication systems. Various embodiments of the present disclosure provide solutions to channel prediction problem(s) from both the data perspective as well as the AI model perspective, resulting in a comprehensive method for the aforementioned problem(s).

Channel prediction is a task in wireless communication systems that aims to estimate the future state or characteristics of a communication channel. This process is useful for optimizing the performance of modern networks such as 5G and 6G, which operate under stringent requirements for reliability, efficiency, and adaptability. By forecasting the evolution of the channel, communication systems can proactively adapt their transmission strategies, improve resource utilization, and enhance overall user experience.

In wireless systems, the communication channel serves as the medium through which signals are transmitted from a transmitter to a receiver. The properties of this channel are highly dynamic and are influenced by various factors, such as multipath propagation, the Doppler effect, and large-scale fading due to environmental changes. Multipath propagation occurs when transmitted signals arrive at the receiver through multiple paths, caused by phenomena like reflection, diffraction, and scattering. This results in constructive and destructive interference, making the received signal highly variable. Similarly, the Doppler effect, which arises from relative motion between the transmitter and receiver, introduces frequency shifts that further complicate the prediction task. Large-scale factors like path loss and shadowing, which depend on the distance and obstacles between the transmitter and receiver, also contribute to channel variability.

The primary objective of channel prediction is to accurately estimate these variations in time, frequency, or spatial domains. For instance, in a time-varying channel, predicting the future state based on past measurements allows the system to adapt transmission parameters such as power, modulation schemes, or coding rates. This can help mitigate the impact of fading or interference, increasing data transmission reliability. Moreover, channel prediction facilitates the optimization of spectral efficiency by allowing communication systems to dynamically allocate resources such as bandwidth and antenna configurations.

Despite its usefulness, channel prediction is a challenging task due to the inherent complexity and unpredictability of wireless channels. The non-stationarity of the environment, particularly in scenarios with high mobility, means that channel characteristics can change rapidly over time. In addition, modern communication systems often involve high-dimensional scenarios, such as massive MIMO configurations, where the task of predicting the channel becomes computationally demanding. Environmental uncertainties, such as unexpected obstacles or weather changes, further add to the difficulty of building robust predictive models.

In wireless communication systems, predicting the channel for UEs moving at high speeds introduces significant challenges. The dynamic nature of the channel is exacerbated by rapid changes in the environment, leading to increased complexity in accurate prediction. One of the primary challenges arises from the rapid temporal variations in the channel, often referred to as fast fading. As UEs move quickly, the relative positions of the transmitter, receiver, and surrounding objects change frequently. This leads to a rapid fluctuation of channel characteristics, such as signal amplitude, phase, and frequency response. The coherence time of the channel, which is the duration over which the channel can be considered approximately constant, becomes extremely short. Traditional prediction models that rely on the assumption of slow-changing channel conditions struggle to adapt in these scenarios. Moreover, high-speed UEs often move through diverse environments, such as urban areas, highways, or rural regions, each with unique propagation characteristics. This environmental non-stationarity introduces additional variability into the channel. For example, urban environments may introduce sudden obstructions or reflections from buildings, while highways may lead to rapid transitions between line-of-sight (LOS) and non-line-of-sight (NLOS) conditions. Adapting channel prediction models to account for such transitions in real time is challenging t.

Apart from high-speed UEs, various embodiments of the present disclosure also address timing offset (TO) and frequency offset (FO) under the context of channel prediction. In wireless communication systems, TO and FO are two impairments that affect the accuracy of channel prediction. These offsets often arise due to imperfections in synchronization between the transmitter and receiver and have significant implications for the performance of communication systems, particularly when channel prediction is employed to optimize transmission. Frequency offset arises from discrepancies between the carrier frequencies of the transmitter and receiver. These discrepancies may result from oscillator imperfections, Doppler shifts due to relative motion, or other environmental factors. Frequency offset is quantified as the difference in frequency between the transmitted and received carrier signals. The primary effect of frequency offset is the introduction of a phase rotation that accumulates over time. This phase rotation affects both the amplitude and phase of the signal, leading to distortion in the received waveform. Timing and frequency offsets have a profound impact on the design and performance of channel prediction systems. Their combined effects can lead to significant degradation in prediction accuracy if not properly accounted for.

Statistical methods have been employed for channel prediction, leveraging models like autoregressive (AR) or autoregressive moving average (ARMA) processes to capture temporal dependencies. Additionally, Kalmann filters can also be used to address these problems. However, these methods often struggle with the complexity and non-linearity of modern communication environments. Various embodiments of the present disclosure leverage machine learning (ML) methods to perform the channel prediction task with TOFO impairments.

In some embodiments, for channel prediction formulation, Hₜ∈ [symbol] may represent the least squares (LS) estimate of a channel at time step t, where a denotes the number of antennas, p denotes the number of subcarriers/RBs. The channel prediction task is then to find a function ƒ_{θ}: [symbol] → [symbol] , which computers the mapping: Hₜ₋ₗ, Hₜ₋ₗ₊₁, . . . , Hₜ [symbol] Ĥₜ₊₁, where Ĥₜ₊₁ is the model's prediction of the channel at time step t+1, given the past l steps of the channel condition. Then for some loss function [symbol] : [symbol] × [symbol] → [symbol] , a parametrization θ of the function ƒ_{θ} is found such that [symbol] (Ĥₜ₊₁, Hₜ₊₁) is minimized. l may be referred to herein as the input lag.

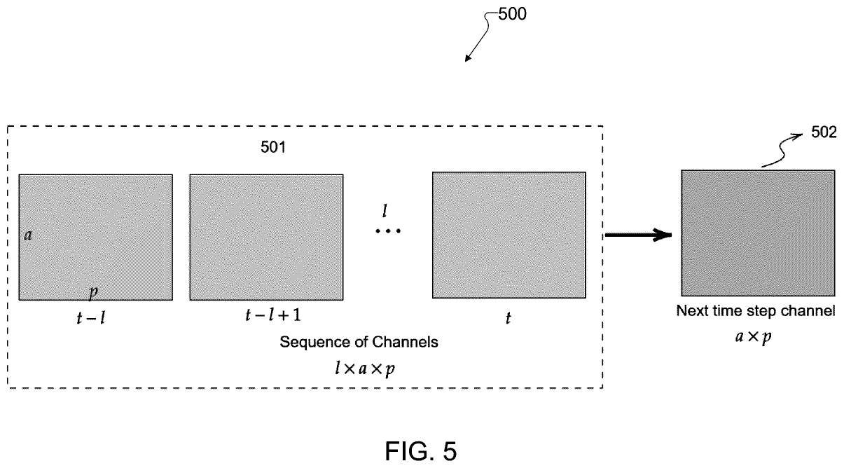

FIG. 5 illustrates an example channel prediction pipeline 500 according to embodiments of the present disclosure. The embodiment of a channel prediction pipeline of FIG. 5 is for illustration only. Different embodiments of a channel prediction pipeline could be used without departing from the scope of this disclosure.

In the example of FIG. 5, the blocks 501 represent the lag-l input data of the channels from the past l TTIs. The data from blocks 501 is used to generate a channel prediction 502 (i.e., the channel at next time step Hₜ₊₁).

Although FIG. 5 illustrates one example channel prediction pipeline 500, various changes may be made to FIG. 5. For example, various changes to the number of past l TTIs use to generate the channel prediction could be made, etc. according to particular needs.

One baseline approach for the channel prediction task is the so-called sample and hold method. Sample and hold uses the last time step channel input to predict the current time step channel, where Ĥₜ₊₁=Hₜ.

In low-speed settings, the sample and hold approach offers reasonable channel prediction performance. However, under high-speed settings, due to the rapid fluctuation of channel characteristics, the sample and hold method becomes extremely unreliable. Various embodiments of the present disclosure provide improved channel prediction reliability over sample and hold based channel prediction strategies. In some circumstances, the embodiments described herein may support a high-speed setting with the UE speed set to 30 kmph.

Some embodiments disclosed herein can involve a channel prediction task under TOFO impairments. For example, in some embodiments, at time step t, for the channel element of i-th antenna and k-th subcarrier, TOFO impairments can be simulated as

$${( {H}_{t}^{′} )}_{i , k} = {( {H}_{t} )}_{i , k} {e}^{j ( 2 π k Δ {T}_{t} + Δ {F}_{t} )} ,$$

at time step t and ΔFₜ is the FO realization at time step t. For the TO realization, let ΔTₜ=Δƒ_{RB}×randTOₜ×Tₛ, where:
a) Δƒ_{RB} is the bandwidth of an RB. For LTE, Δƒ_{RB}=180 KHz.
b) Tₛ is the sampling period. For LTE, Tₛ=32 ns.
c) randTOₜ=c+ε, where 0≤c<8 is a constant and e is drawn uniformly from the set {−1,0,1}.
   For the FO realization, let ΔFₜ=randFO×tk, where randFO˜U(−α, α) for some constant α and t is the TTI. For all experiments described herein, α=π. Then the channel prediction task under TOFO impairments can be formally defined as to find a function ƒθ: [symbol] → [symbol] , which computes the mapping: H′ₜ₋ₗ, H′ₜ₋ₗ₊₁, . . . , H′ₜ [symbol] Ĥₜ₊₁, where Ĥₜ₊₁ is the model's prediction of the clean channel at time step t+1, given the past l steps of the TOFO impaired channel conditions.

In some embodiments, Xcorrelation (Xcorr) may be used as an evaluation metric of the channel prediction task. Xcorrelation is useful as an evaluation metric, as it is closely related to the final throughput of the telecommunication networks. Formally, given a target channel matrix H and its prediction Ĥ of size a×p, the Xcorrelation is defined as

$$Xcorr ( \hat{H} , H ) = \frac{1}{p} {\sum }_{i = 1}^{p} \frac{‖ 〈 {\hat{H}}_{: , i} , {H}_{: , i} 〉 ‖}{‖ {\hat{H}}_{: , i} ‖ ‖ {H}_{: , i} ‖} ,$$

where ∥⋅∥ denotes the complex norm, and [symbol] ⋅,⋅ [symbol] denotes the complex vector inner product. One can note this metric is invariant under phase shift. Namely for any Φ, Ĥ=H·e^{jΦ} gives the same XCorrelation performance. Additionally, the range of Xcorrelation is from 0 to 1, with a higher Xcorrelation score representing a better result. Various embodiments of the present disclosure, use Xcorrelation as the evaluation metric and use negative Xcorrelation as the loss function. However, the embodiments described herein can be used with any arbitrary loss function and evaluation metric. Should the need for evaluation change, one can easily swap the loss function with the desired metric. In some cases, various embodiments of the present disclosure do not require additional changes.

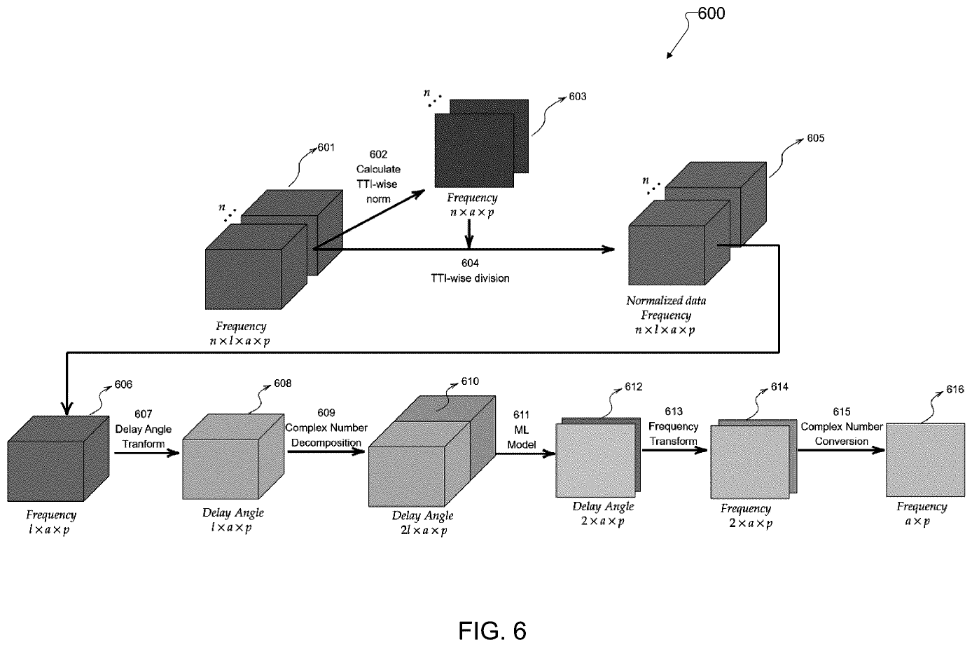

For data preprocessing, some embodiments may use a data preprocessing pipeline as shown in FIG. 6.

FIG. 6 illustrates an example data preprocessing pipeline 600 according to embodiments of the present disclosure. The embodiment of a data preprocessing pipeline of FIG. 6 is for illustration only. Different embodiments of a data preprocessing pipeline could be used without departing from the scope of this disclosure.

In the example of FIG. 6, the data preprocessing pipeline 600 includes two preprocessing methods:
a. TTI-wise normalization: Different antennas and different subcarriers often tend to have different power magnitudes, but the magnitudes along the TTI dimension are often consistent. Therefore, power normalization can be performed in a TTI-wise fashion. To do so, first the TTI-wise average of the input tensor is obtained. Then each TTI slice of the input tensor is divided by the aforementioned TTI-wise average. More formally, given an input tensor H′∈ [symbol] , where n is the number of examples, l is the input lag (TTI-dimension), a is the number of antennas and p is the number of subcarriers. The TTI-wise average Z∈ [symbol] is obtained by

$$Z = \frac{1}{l} {\sum }_{i = 1}^{l} {H}_{: , i , : , :}^{′} .$$

Then the TTI-wise normalization is performed by computing the element-wise division of the two tensors

$${H}_{: , i , : , :}^{′} = \frac{{H}_{: , i , : , :}^{′}}{Z} , ∀ i ∈$$

b. Delay-Angle domain transformation: The input data comes in under frequency domain. We perform delay-angle domain transformation by first converting the data from frequency domain to delay domain using inverse Fourier transformation (IFT) along the subcarrier dimension. We then convert the data from delay domain to delay-angle domain by performing another IFT along the antenna dimension.

In the data preprocessing pipeline 600, the data preprocessing and post processing is performed as follows. In operation 601, an input data tensor is received under the frequency domain. Then in operation 602, the TTI-wise average is computed, and the TTI-wise normalization is applied in operation 604 by performing TTI-wise division. In operation 607 delay-angle transformation is performed. In operation 609 the complex tensor is decomposed into real and imaginary parts, and the decomposed tensor is concatenated together along the TTI dimension. The transformed data is passed to an arbitrary machine learning (ML) model in operation 611 to obtain the delay-angle domain prediction in operation 612. In operation 613 the prediction is converted back to the frequency domain by first applying a Fourier transform (FT) on the antenna dimension and applying another FT on the subcarrier dimension thereafter. Finally, the final frequency domain next time step channel prediction is obtained at 616 through operation 615 where the complex tensor is converted back from its decomposed form.

Although FIG. 6 illustrates one example data preprocessing pipeline 600, various changes may be made to FIG. 6. For example, additional operations could be added to the pipeline, one or more of the operations in the pipeline could be omitted, etc. according to particular needs.

In some embodiments, a data preprocessing pipeline such as shown in FIG. 6 may employ a residual neural networks (ResNet) based ML model (for example, at operation 611). ResNet is a deep learning architecture introduced to address the problem of vanishing gradients that often occurs when training very deep neural networks. ResNet introduces residual blocks, which allow the network to learn residual functions with reference to the layer inputs, rather than trying to learn unreferenced functions. Each residual block includes shortcut connections that bypass one or more layers, enabling the network to learn identity mappings. This architecture allows very deep networks to be trained efficiently by mitigating the degradation problem, where increasing depth leads to higher training error. The primary benefit of ResNet is that it enables the construction of extremely deep networks, such as ResNet-50, ResNet-101, and even deeper, without suffering from vanishing gradients, leading to improved accuracy in complex tasks. ResNet has been widely adopted in various applications, including image classification, object detection, and image denoising/restoration, where its ability to learn deep and complex features has set new benchmarks in performance.

In some embodiments, for ResNet based ML models, as well as other ML models described herein, given an ML model ƒ_{θ} parameterized by θ, an input tensor H′∈ [symbol] , and the target next time step channel H′ₜ₊₁∈ [symbol] , the preprocessing function is denoted as u: [symbol] → [symbol] , and the postprocessing function is denoted as v: [symbol] → [symbol] , where u and v correspond to the preprocessing (e.g., operations 601 to 611) and postprocessing (e.g., operation 613 to 616) routines described herein. In embodiments such as these the following optimization process θ=argmin_{θ}Xcorr{v(ƒ_{θ}(u(H′))),H′ₜ₊₁} is performed. Note that by doing so, the optimization process is performed under the frequency domain.

In various embodiments of the present disclosure, it is presumed that the preprocessing and postprocessing routines can always be performed. Therefore, when the context is clear, the preprocessing and postprocessing functions in equations and figures is omitted hereinafter.

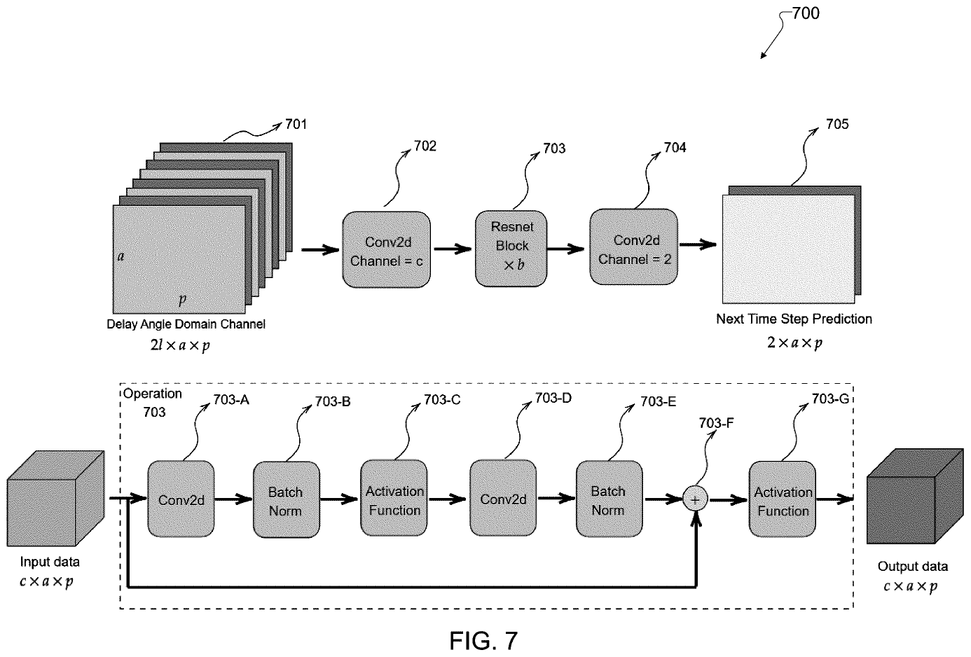

In some embodiments, an ML model may adopt a framework as shown in FIG. 7.

FIG. 7 illustrates an example ResNet model structure 700 according to embodiments of the present disclosure. The embodiment of a ResNet model structure of FIG. 7 is for illustration only. Different embodiments of a ResNet model structure could be used without departing from the scope of this disclosure.

In the example of FIG. 7, in operation 702, the input signals are projected to channel size c using a standard 2D convolution layer. Then in operation 703, various numbers of ResNet blocks are stacked, whose architecture is shown in the bottom of FIG. 7. The input data is fed through a series of 2D convolution, batch-normalization as well as activation functions, through operations 703-A to 703-E. After, the skip connection is applied in operation 703-F to obtain the sum of the layer input and the output features of 703-E, and this is subsequently fed into the activation function and the output of the ResNet block is obtained. Finally, in operation 704, another 2D convolution layer is applied to project the channel dimension back to size 2 to recover the predicted channel.

Although FIG. 7 illustrates one example ResNet model structure 700, various changes may be made to FIG. 7. For example, various changes to the number and type of ResNet blocks could be made, etc. according to particular needs.

In the following text, the nomenclature ResNet xByC is used to denote a ResNet model with x number of blocks and y number of hidden channels. When the context is clear, ResNet is omitted from the beginning of the nomenclature.

Experiments were performed using a ResNet model structure as described above regarding FIG. 7. In these experiments, a ResNet model was configured to be 4B128C and a hyperparameter search was conducted for number of lags (l) and the kernel size of the convolution layers. An optimizer with the learning rate set to be 0.001 was used to train on the dataset of 460,265 training sequences. ReduceOnPlateau was used for the learning rate scheduler, where if for a number of training epochs, if the validation loss did not improve, the learning rate was decreased. In all experiments described herein, the factor parameter was set to be 0.5 and the patience parameter was set to be 10. That is, if for 10 training epochs, validation loss did not improve, the current learning rate was multiplied by 0.5. The following results report the testing Xcorrelation (Xcorr) score, along with the number of floating point operations per second (FLOPs), and number of model parameters, as well as the model size in terms of storage.

Table 1 shows example results of an example experiment exploring different size setups for a ResNet solution as described herein. In the example experiment of Table 1, four different kernel sizes (1, 1), (1, 3), (3, 1) and (3, 3) were used for the base model 4B128C with an input lag 50. Note that the data image is of size n×2l×a×p, where the last dimensions are antenna and subcarriers, respectively.

TABLE 1
Example Hyperparameter search for kernel size

| Model | Kernel | | | | | Model |
|---|---|---|---|---|---|---|
| configuration | size | Lag | Xcorr | FLOPs | #Parameters | size (Mb) |
| 4B128C | 1, 1 | 50 | 0.650 | 471M | 147K | 0.57 |
| 4B128C | 1, 3 | 50 | 0.784 | 1.39G | 435K | 1.7 |
| 4B128C | 3, 1 | 50 | 0.650 | 1.39G | 435K | 1.7 |
| 4B128C | 3, 3 | 50 | 0.642 | 4.16G | 1.3M | 4.96 |

In Table 1, it can be seen that the kernel size (1, 3) shows great Xcorrelation performance, reaching 0.784, as an example. The rest perform similarly at around 0.65 Xcorrelation. The (3, 3) kernel size fails to reach to the similar performance as (1, 3). This is due to a strong overfitting phenomenon happening for (3, 3) kernel size. To alleviate this issue, dropout can be used as a regularization method for the (3, 3) ResNet model. Experimentation with 0.3 and 0.5 dropout rate is shown in Table 2.

TABLE 2
Example Using dropout to alleviate overfitting caused by (3, 3) kernel size

| Model | | | | | | | |
|---|---|---|---|---|---|---|---|
| configuration | Dropout | Kernel size | Lag | Xcorr | FLOPs | #Parameters | Model size (Mb) |
| 4B128C | 0 | 3, 3 | 50 | 0.642 | 4.16G | 1.3M | 4.96 |
| 4B128C | 0.3 | 3, 3 | 50 | 0.748 | 4.16G | 1.3M | 4.96 |
| 4B128C | 0.5 | 3, 3 | 50 | 0.724 | 4.16G | 1.3M | 4.96 |
| 4B128C | 0 | 1, 3 | 50 | 0.784 | 1.39G | 435K | 1.7 |

As can be seen in Table 2, dropout significantly improves the Xcorrelation performance, but the (3, 3) kernel size still underperforms the (1, 3) kernel size. One other interesting phenomenon to observe is that (3, 1) and (1, 1) kernel sizes perform exactly the same while significantly underperforming the (1, 3) kernel size. This indicates that the correlation on the antenna dimension serves no use in terms of the channel prediction problem under Xcorrelation. Furthermore, based on the overfitting issue observed with (3, 3) kernel size, it can be seen that this correlation actually hurts the learning process. In conclusion, the model takes advantage of the subcarrier dimension correlation to perform the channel prediction task under Xcorrelation, while the antenna dimension correlation is of no significant use. Hereinafter, a (1, 3) kernel size is used when a convolution operation on the antenna-subcarrier dimension is involved.

Table 3 shows the results of an experiment exploring the effect of different input lags on the channel prediction task under Xcorrelation. This experiment used a 4B128C model with (1, 3) kernel size, and input lags ranging from 2 to 50.

TABLE 3
Example Hyperparameter search on different input lags.

| Model | Kernel | | | | | Model |
|---|---|---|---|---|---|---|
| configuration | size | Lag | Xcorr | FLOPs | #Parameters | size (Mb) |
| 4B128C | 1, 3 | 50 | 0.784 | 1.39G | 435K | 1.7 |
| 4B128C | 1, 3 | 40 | 0.782 | 1.37G | 428K | 1.6 |
| 4B128C | 1, 3 | 30 | 0.751 | 1.34G | 420K | 1.6 |
| 4B128C | 1, 3 | 20 | 0.710 | 1.32G | 413K | 1.6 |
| 4B128C | 1, 3 | 10 | 0.613 | 1.29G | 404K | 1.5 |
| 4B128C | 1, 3 | 5 | 0.523 | 1.28G | 401K | 1.5 |
| 4B128C | 1, 3 | 2 | 0.503 | 1.28G | 398K | 1.5 |

It can be seen in Table 3 that 50 input lag achieved great performance at 0.784, as an example. However, with 40 input lag, the performance only decreased by 0.002. Starting from 30 input lag, some significant performance degradation it seen. It appears that with 50 and 40 input lag, the performances roughly converge to the same. Therefore, additional experiments herein opt to use 50 as the input lag.

Table 4 shows the results of an experiment exploring three different ResNet models (4B32C, 4B128C, 4B256C) compared with the sample and hold method.

TABLE 4
Example ResNet model performance on Xcorrelation metric
comparing with the baseline sample and hold method.

| Model | | | | | | |
|---|---|---|---|---|---|---|
| configuration | Kernel size | Lag | Xcorr | FLOPs | #Parameters | Model size (Mb) |
| 4B32C | 1, 3 | 50 | 0.650 | 112M | 35K | 0.14 |
| 4B128C | 1, 3 | 50 | 0.784 | 1.39G | 428K | 1.7 |
| 4B256C | 1, 3 | 50 | 0.796 | 5.30G | 1.65M | 6.3 |
| Sample and Hold | NA | NA | 0.501 | NA | NA | NA |

It can be seen in Table 4 that across the board, ResNet solutions outperform the sample and hold method significantly, with sample and hold reaching 0.501, with ResNet 4B32C reaching 0.65, which is the worst performer of the tested ResNet configurations. As an example, it can be seen that ResNet 4B256C achieves great Xcorrelation performance at 0.796, which slightly outperforms 4B128C. However, the complexity of 4B256C is about four times the complexity for 4B128C, similarly for the number of parameters as well as the model size. This example experiment shows the strong performance of a ResNet model over the sample and hold method.

An ablation study was conducted using the data preprocessing pipeline presented in FIG. 6 experimenting with the following three setups:
a. Only delay-angle transformation: keeping only operations 606 to 608 and 613 while removing the TTI-wise normalization (operations 601 to 605)
b. Only TTI-wise normalization: keeping only operations 601 to 605 while discarding the delay-angle transformation.
c. All steps: the original setting in FIG. 6, keeping both the TTI-wise normalization as well as delay-angle transformation.

Table 5 shows the results of experiments for all the three ablation setups on three ResNet configurations (4B32C, 4B128C, 4B256C).

TABLE 5
Example Ablation studies on data preprocessing and postprocessing methods

| | | | | | | | Model |
|---|---|---|---|---|---|---|---|
| Model | | Kernel | | | | | size |
| configuration | Data Preprocessing | size | Lag | Xcorr | FLOPs | #Parameters | (Mb) |
| 4B32C | All steps | 1, 3 | 50 | 0.650 | 112M | 35K | 0.14 |
| 4B128C | All steps | 1, 3 | 50 | 0.784 | 1.39G | 428K | 1.7 |
| 4B256C | All steps | 1, 3 | 50 | 0.796 | 5.30G | 1.65M | 6.3 |
| 4B32C | Only delay-angle transform | 1, 3 | 50 | 0.121 | 112M | 35K | 0.14 |
| 4B128C | Only delay-angle transform | 1, 3 | 50 | 0.153 | 1.39G | 428K | 1.7 |
| 4B256C | Only delay-angle transform | 1, 3 | 50 | 0.176 | 5.30G | 1.65M | 6.3 |
| 4B32C | Only TTI-wise normalization | 1, 3 | 50 | 0.563 | 112M | 35K | 0.14 |
| 4B128C | Only TTI-wise normalization | 1, 3 | 50 | 0.596 | 1.39G | 428K | 1.7 |
| 4B256C | Only TTI-wise normalization | 1, 3 | 50 | 0.601 | 5.30G | 1.65M | 6.3 |

It can be seen in Table 5 that without the TTI-wise normalization, the Xcorrelation performances of all ResNet models decline to around 0.15, which is worse than the sample and hold baseline method. Additionally, without the delay-angle transformation, although a significant improvement can be seen compared to only using delay-angle transformation (for example, 4B256C reaches to 0.6 Xcorrelation), the general performance is still significantly worse than when using all steps of the data preprocessing and postprocessing methods. Overall, both delay-angle transformation as well as the TTI-wise normalization in the embodiments of FIG. 6 provides great performance for leveraging AI methods for the channel prediction task.

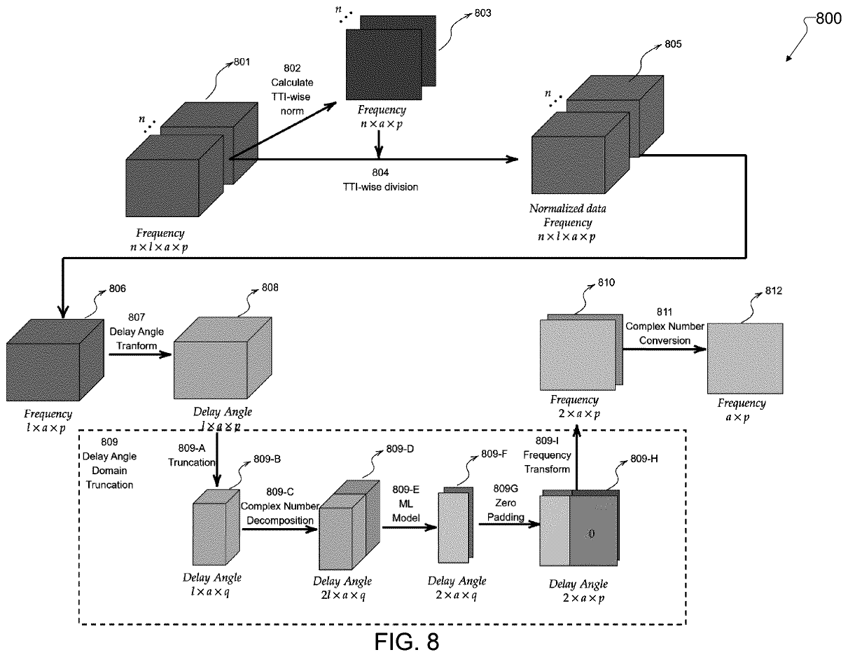

The example great performing model above (ResNet 4B256C) is computationally intensive, with a floating-point operation count (FLOPs) reaching approximately 5.30G. Deploying such a resource-heavy model in telecommunication networks may necessitate significant infrastructure upgrades, leading to high costs. Therefore, reducing the overall complexity of the model and AI framework is desirable. In the framework described herein (e.g., in FIG. 6), the ML model operates on the delay-angle domain of the input data. After the delay-angle transformation, signal power is typically concentrated in the first few resource blocks (RBs), while the remaining RBs often exhibit negligible or zero signal power. Additionally, the computational complexity of the ResNet model is primarily driven by convolution operations, which can be substantially reduced through downsampling. To address this, a viable solution for reducing the complexity of the AI framework for channel prediction is to truncate the input data along the RBs dimension, effectively downsampling the input while preserving important information. An example solution employing these techniques is shown in FIG. 8.

FIG. 8 illustrates an example delay-angle domain truncation for reducing computation complexity of ML models 800 according to embodiments of the present disclosure. The embodiment of delay-angle truncation of FIG. 8 is for illustration only. Different embodiments of a delay-angle domain truncation for reducing computation complexity of ML models could be used without departing from the scope of this disclosure.

The example of FIG. 8 shows an entire pipeline similar as described regarding FIG. 6 except with delay-angle domain truncation. For example, operations 801 through 808 of FIG. 8 correspond to operations 601 through 608 of FIG. 6, and operations 810 through 812 of FIG. 8 correspond with operations 614 through 616 of FIG. 6.

In the example of FIG. 8, after obtaining the delay-angle transformation of the input data in operation 808, the first q RBs are kept while truncating the remaining p−q RBs by performing the truncation operation in operation 809-A. This gives an input tensor of shape l×a×q. The input complex tensor is then decomposed into its real and imaginary part in operation 809-C, obtaining the input tensor of shape 2l×a×q. The truncated input tensor is then fed through an arbitrary ML model to obtain a prediction of size 2l×aλq under the delay-angle domain in operation 809F. As earlier described, except for the first few RBs, all the remaining RBs under the delay-angle domain often exhibit negligible or zero signal power. Therefore, in operation 809-G, zero-padding is performed on the obtained prediction, where zeros are padded on the RBs dimension to reach to the prediction size of 2l×a×p. Finally, the prediction is converted back to the frequency domain to obtain the final prediction.

Although FIG. 8 illustrates one example delay-angle domain truncation for reducing computation complexity of ML models 800, various changes may be made to FIG. 8. For example, various changes to the number of RBs being kept could be made, etc. according to particular needs.

Table 6 shows the results of an experiment using the delay-angle domain truncation method of FIG. 8 with different number of RBs being kept, (i.e., the q parameter the discussion regarding FIG. 8), ranging from 50 (no RBs being truncated) to 5 (45 RBs being truncated).

TABLE 6
Example Complexity reduction via truncation on the
subcarrier dimension in the delay-angle domain

| Model | | | # RBs | | | | |
|---|---|---|---|---|---|---|---|
| configuration | Kernel size | Lag | kept (q) | Xcorr | FLOPs | #Parameters | Model size (Mb) |
| 4B128C | 1, 3 | 50 | 50 | 0.784 | 1.39G | 435K | 1.7 |
| 4B128C | 1, 3 | 50 | 40 | 0.780 | 1.12G | 435K | 1.7 |
| 4B128C | 1, 3 | 50 | 30 | 0.778 | 836M | 435K | 1.7 |
| 4B128C | 1, 3 | 50 | 20 | 0.775 | 557M | 435K | 1.7 |
| 4B128C | 1, 3 | 50 | 10 | 0.748 | 278M | 435K | 1.7 |
| 4B128C | 1, 3 | 50 | 5 | 0.682 | 139M | 435K | 1.7 |

It can be seen in Table 6 that for ResNet 4B128C, the delay-angle domain truncation is not performed, the number of FLOPs is at 1.39G. As q is decreased (i.e., the number of RBs truncated is increased), a significant drop in the number of FLOPs can be seen. For example, when q=5, the number of FLOPs is only 139M, about 10 times less than performing no truncation. Nevertheless, a tradeoff is apparent. If q is set too low (too many RBs are truncated) a significant degradation can be observed on the Xcorrelation performance. However, based on the example experiment results, it seems when q=20, almost no performance decline (about 0.01 difference) is suffered while still obtaining a significant drop on the number of FLOPs (557M, compared to 1.39G).

Note that the techniques described herein are suitable for any arbitrary ML model, as it is a part of the data preprocessing and postprocessing routine. Although convolution-based models can benefit from these techniques significantly due to the reduced spatial dimension, in some cases, these techniques can also be leveraged with other ML models to achieve better model complexity.

Video frame prediction is a task in machine learning that focuses on predicting future frames in a video sequence based on a series of observed past frames. This problem lies at the intersection of spatial and temporal modeling, as it may require understanding the spatial features within each frame while also capturing the temporal dynamics that govern their evolution over time.

In this task, one goal is to predict one or more future frames, given a sequence of past frames. Each frame is typically represented as a two-dimensional or three-dimensional array, containing pixel intensity values or other visual information. The challenge lies in accurately modeling both the motion of objects and the changes in appearance or structure within the video.

In recent years, advances in machine learning, particularly deep learning, have enabled significant progress in video frame prediction. Convolutional Neural Networks (CNNs) can be used to capture spatial features, while architectures such as Recurrent Neural Networks (RNNs), Long Short-Term Memory (LSTM) networks, and Gated Recurrent Units (GRU) networks can be employed to model temporal dependencies. Variants like ConvLSTMs can combine the strengths of CNNs and LSTMs to handle spatiotemporal data more effectively.

Channel prediction and video frame prediction, while arising in distinct domains of wireless communication and computer vision respectively, share fundamental similarities in their core problem structure and methodological approaches. Both tasks involve the forecasting of future states in dynamic systems based on historical observations. This similarity is rooted in the spatiotemporal nature of the data they process and the challenges they aim to address.

At their core, both channel prediction and video frame prediction may utilize the modeling of temporal dependencies to extrapolate future outcomes. In channel prediction, the temporal evolution of the wireless channel is influenced by factors such as user mobility, environmental changes, and multipath effects. The channel prediction task involves estimating future channel states, such as amplitude, phase, or frequency response, based on prior observations. Similarly, video frame prediction is based on modeling the temporal evolution of visual data, capturing motion and appearance changes across successive frames in a video sequence.

Another similarity lies in the importance of accounting for spatial patterns. In channel prediction, spatial dependencies may arise in scenarios involving multiple-input multiple-output (MIMO) systems or when considering spatial correlations between nearby channels in a wireless network. In video frame prediction, spatial modeling involves understanding the spatial structure of visual elements within each frame, such as objects, textures, and background features. Both tasks benefit from effective mechanisms to jointly capture spatial and temporal relationships in the data.

Additionally, both tasks face similar challenges related to data complexity and non-stationarity. In channel prediction, non-stationarity arises due to dynamic environmental conditions and user mobility, which make the channel characteristics highly variable over time. Video frame prediction faces analogous challenges, as the appearance and motion of objects in a video can change unpredictably due to factors like occlusions, lighting variations, or interactions between objects. Both tasks may use models that can generalize across diverse conditions while remaining robust to noise and uncertainty.

Recurrent Neural Networks (RNNs) are a class of artificial neural networks designed for sequence data. Unlike traditional feedforward neural networks, RNNs have connections that allow information to persist across different steps in a sequence. This capability makes RNNs particularly suitable for tasks where context and temporal dynamics are important, such as time series analysis, natural language processing, and signal processing. RNNs process sequences of data one step at a time, maintaining a hidden state that captures information from previous steps. The same weights are used for all steps in the sequence, enabling the model to generalize across different positions in the sequence. During training, RNNs leverage Backpropagation Through Time (BPTT) which unrolls the network through time to compute gradients.

Traditional RNNs suffer from the vanishing gradient problem, where gradients propagated through many time steps can become extremely small, preventing the network from learning long-term dependencies effectively. This issue limits the capability of RNNs to retain information over long sequences. The introduction of gating mechanisms in Long Short-Term Memory (LSTM) networks and Gated Recurrent Unit (GRU) networks was a significant breakthrough in overcoming this limitation. Gating mechanisms allow the network to control the flow of information, enabling better handling of dependencies across different time steps.

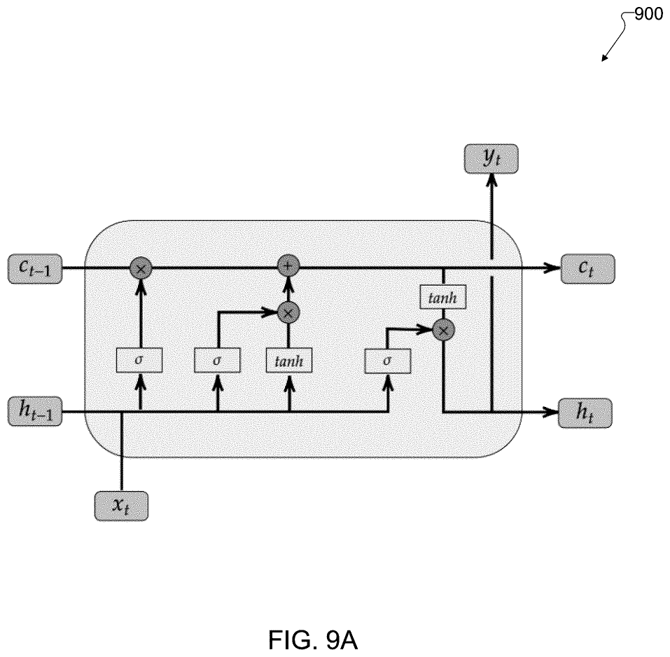

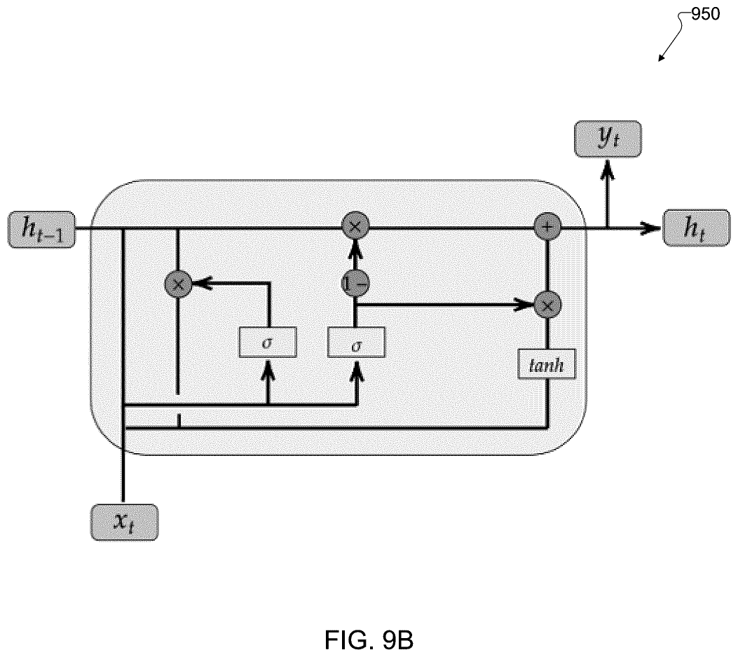

LSTMs introduce a cell state that runs through the entire sequence, providing a pathway for gradients to flow without vanishing. LSTMs use three gates—the input gate, the forget gate, and the output gate—to regulate the cell state and the hidden state. Gated Recurrent Units (GRUs) simplify the LSTM architecture by combining the forget and input gates into a single update gate and using a reset gate to control the candidate activation. Various embodiments of the present disclosure may utilize GRUs. GRUs uses two gates—the update gate and the reset gate—to control the flow of information. The update gate decides how much of the past information may need to be passed along to the future, while the reset gate determines how much of the past information to forget. Compared to Long Short-Term Memory (LSTM) networks, GRUs have a simpler architecture with fewer parameters, which can make them faster to train and easier to implement. GRUs have been shown to perform comparably to LSTMs on many tasks while being computationally more efficient. FIGS. 9A and 9B illustrate the structure of LSTM and GRU units.

FIG. 9A illustrates an example structure of LSTM units 900 according to embodiments of the present disclosure. The embodiment of a structure of LSTM units of FIG. 9A is for illustration only. Different embodiments of a structure of LSTM units could be used without departing from the scope of this disclosure.

LSTMs with the structure shown in FIG. 9A have the following update rules:

$${f}_{t} = σ ( {W}_{f} {x}_{t} + {U}_{f} {h}_{t - 1} + {b}_{f} )$$

$${i}_{t} = σ ( {W}_{i} {x}_{t} + {U}_{i} {h}_{t - 1} + {b}_{i} )$$

$${o}_{t} = σ ( {W}_{o} {x}_{t} + {U}_{o} {h}_{t - 1} + {b}_{o} )$$

$${\tilde{c}}_{t} = tanh ( {W}_{c} {x}_{t} + {U}_{c} {h}_{t - 1} + {b}_{c} )$$

$${c}_{t} = {f}_{t} ⊙ {c}_{t - 1} + {i}_{t} ⊙ {\tilde{c}}_{t}$$

$${h}_{t} = {o}_{t} ⊙ tanh ( {c}_{t} )$$

Where x denotes the input vector, c denotes the cell state, h denotes the hidden states, σ denotes sigmoid activation function, tan h denotes the hyperbolic tangent function, and ⊙ denotes Hadamard product.

Although FIG. 9A illustrates one example structure of LSTM units 900, various changes may be made to FIG. 9A. For example, various changes to the update rules could be made, etc. according to particular needs.

FIG. 9B illustrates an example structure of GRU units 950 according to embodiments of the present disclosure. The embodiment of a structure of GRU units of FIG. 9B is for illustration only. Different embodiments of a structure of GRU units could be used without departing from the scope of this disclosure.

GRUs with the structure shown in FIG. 9B have the following update rules:

$${z}_{t} = σ ( {W}_{z} {x}_{t} + {U}_{z} {h}_{t - 1} + {b}_{z} )$$

$${r}_{t} = σ ( {W}_{r} {x}_{t} + {U}_{r} {h}_{t - 1} + {b}_{r} )$$

$${\tilde{h}}_{t} = tanh ( {W}_{z} {x}_{t} + {U}_{h} ( {r}_{t} ⊙ {h}_{t - 1} ) + {b}_{z} )$$

$${h}_{t} = ( 1 - {z}_{t} ) ⊙ {h}_{t - 1}$$

Where x denotes the input vector, h denotes the hidden states, σ denotes sigmoid activation function, tan h denotes the hyperbolic tangent function, and ⊙ denotes Hadamard product.

Although FIG. 9B illustrates one example structure of GRU units 950, various changes may be made to FIG. 9B. For example, various changes to the update rules could be made, etc. according to particular needs.

Convolutional Long Short-Term Memory (ConvLSTM) is a deep learning architecture designed to handle spatiotemporal data effectively by combining the strengths of Convolutional Neural Networks (CNNs) and Long Short-Term Memory (LSTM) networks. It was introduced to address the limitations of traditional LSTMs in modeling data that exhibit strong spatial correlations, such as video sequences, weather data, or, in this case, wireless communication channels.

Traditional LSTMs are widely used for sequence modeling due to their ability to capture long-term dependencies in temporal data. However, traditional LSTMs process inputs as one-dimensional vectors, which makes them inefficient for tasks that may require preserving the spatial structure of data. For example, in video frame prediction, flattening image frames into vectors before inputting them into an LSTM leads to a loss of spatial information, which is beneficial for understanding patterns within each frame.

Convolutional LSTM (ConvLSTM) overcomes this limitation by integrating convolutional operations directly into the LSTM framework. Instead of using fully connected layers in the input-to-hidden and hidden-to-hidden transitions, ConvLSTM replaces these with convolutional layers. This modification allows ConvLSTM to process data with a spatial structure, such as images or feature maps, while retaining the temporal modeling capabilities of LSTMs.

Note that all the hidden states are flattened vectors in these update rules. ConvRNN-based approaches, i.e. ConvLSTM and convolutional gated recurrent unit (ConvGRU), make a simple change to the update rules described with respect to FIGS. 9A and 9B to accommodate for spatial-aware hidden states. They replace all matrix vector products in the traditional LSTM and GRU update rules with convolution operations. Namely for ConvLSTM, the update rules are as follows:

$${F}_{t} = σ ( {W}_{f} * {X}_{t} + {U}_{f} * {hG}_{t - 1} + {B}_{f} )$$

$${I}_{t} = σ ( {W}_{i} * {X}_{t} + {U}_{i} * {G}_{t - 1} + {B}_{i} )$$

$$O = σ ( {W}_{o} * {X}_{t} + {U}_{o} * {G}_{t - 1} + {B}_{o} )$$

$${\tilde{C}}_{t} = tanh ( {W}_{c} * {X}_{t} + {U}_{c} * {G}_{t - 1} + {B}_{c} )$$

$${C}_{t} = {F}_{t} ⊙ {C}_{t - 1} + {I}_{t} ⊙ {\tilde{C}}_{t}$$

$${G}_{t} = {O}_{t} ⊙ tanh ( {C}_{t} )$$

Where * denotes the convolution operation. Note that capital letters denote matrices/tensors, Xₜ∈ [symbol] , Hₜ∈ [symbol] , and Cₜ∈ [symbol] , for some predefined hidden channel size c. Similarly, for ConvGRU, you have:

$${Z}_{t} = σ ( {W}_{z} * {X}_{t} + {U}_{z} * {G}_{t - 1} + {B}_{z} )$$

$${R}_{t} = σ ( {W}_{r} * {X}_{t} + {U}_{r} * {G}_{t - 1} + {B}_{r} )$$

$${\tilde{G}}_{t} = tanh ( {W}_{z} * {X}_{t} + {U}_{h} * ( {R}_{t} ⊙ {G}_{t - 1} ) + {B}_{z} )$$

$${G}_{t} = ( 1 - {Z}_{t} ) ⊙ {H}_{t - 1}$$

ConvLSTM offers several advantages over traditional LSTMs and CNNs when dealing with spatiotemporal data. First, ConvLSTM preserves spatial information by performing convolutional operations, making ConvLSTM highly effective for tasks where spatial patterns play a key role. Second, ConvLSTM models temporal dependencies through its recurrent structure, enabling ConvLSTM to capture long-term dynamics in data sequences. This combination makes ConvLSTM particularly suitable for applications such as video frame prediction, precipitation forecasting, and dynamic scene understanding. Another advantage of ConvLSTM is its parameter efficiency. By using convolutional layers instead of fully connected layers, the number of learnable parameters is reduced, making the model more efficient and less prone to overfitting, especially when dealing with high-dimensional inputs like images.

Despite its advantages, ConvLSTM faces challenges when applied to complex real-world scenarios. One limitation is the computational cost associated with performing convolutions in high-dimensional data. This can make training and inference computationally expensive for large datasets or high-resolution inputs. Additionally, while ConvLSTM is effective at modeling short- to medium-term dependencies, capturing very long-term temporal patterns may still benefit from architectural enhancements or hybrid approaches.

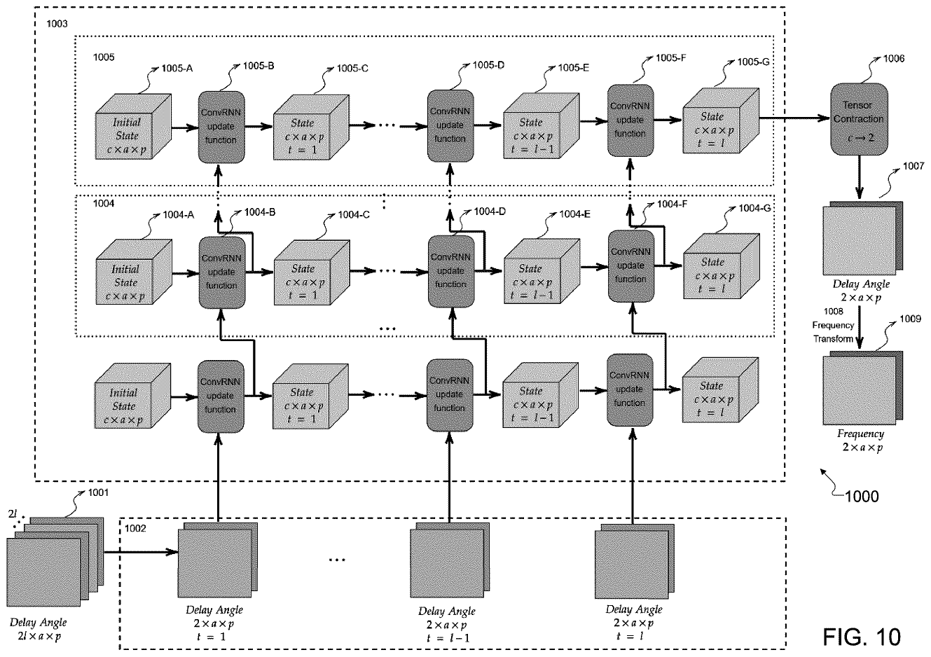

FIG. 10 illustrates an example model framework for multiple layers of ConvRNN networks 1000 according to embodiments of the present disclosure. The embodiment of a model framework for multiple layers of ConvRNN networks of FIG. 10 is for illustration only. Different embodiments of a model framework for multiple layers of ConvRNN networks could be used without departing from the scope of this disclosure.

In the example of FIG. 10, the data preprocessing and post processing procedures as described regarding FIG. 6 are omitted. In operation 1001, the input data comes in under the delay-angle domain with its real-imaginary decomposed form. Then without loss of generality, it can be assumed the TTI of the input data ranges from 1 to l. In operation 1002, the data tensor is split based on its TTI index and the split data is arranged in an increasing order with respect to the TTI index. This can be seen as treating the input data as its original sequential format, where at each TTI, the input is the real-imaginary decomposed channel at the current time step. The sequential data is fed into operation 1003 which is a multi-layer ConvRNN. Generally speaking, each layer of the ConvRNN takes the form of operation 1004. At operation 1004-A, there is a learnable initial state of size c×a×p, where c denotes the hyperparameter of the number of hidden channels. Then in operation 1004-B, there is a general ConvRNN update function. This function takes a general form, which takes the previous layer's output and the state of the previous time step as input and output next time step hidden state. Note this general form can take any arbitrary RNN form, as long as it operates on spatial-aware hidden states. For example, the ConvRNN update function can both take the forms of the aforementioned ConvLSTM unit as well as a ConvGRU unit. Then, this operation will repeat l times, until reaching the last TTI and obtain the final state 1004-G of the current layer. This layer can be repeated multiple times until reaching a desired depth and the number of layers is a hyperparameter and can be tuned via cross validation. After repeating operation 1004 for a desired number of times, the output layer at operation 1005 is reached. This operation is similar to operation 1004 except that the output of each ConvRNN update function may no longer be fed into the next layer. Finally, the last state of the network is reached at 1005-G. A tensor contraction is then applied with a learnable weight matrix of size c×2 in operation 1006 to convert the final state of size c×a×p to output shape 2×a×p. The delay-angle domain prediction is then obtained in operation 1007 and subsequently converted into the frequency domain in operation 1008.

Although FIG. 10 illustrates one example model framework for multiple layers of ConvRNN networks 1000, various changes may be made to FIG. 10. For example, various changes to the number of layers could be made, etc. according to particular needs.

Experiments were performed using a ConvRNN framework for the channel prediction task as described above regarding FIG. 10. In these experiments, both ConvLSTM as well as ConvGRU were utilized. Similar to other experiments discussed herein, the kernel size of the convolution operation was set to be (1, 3), and 50 was used as the input lag. The notation xLyC is used herein to denote a ConvRNN with x layers and y hidden channels. The experimental results are compared with ResNet as well as sample and hold methods as discussed herein.

Table 7 shows the example experiment results of the ConvRNN framework and uses ConvGRU and ConvLSTM as two special cases. For both of the networks, a 4-layers-with-64-hidden channels architecture was used.

TABLE 7
Example Experiment results for ConvRNN framework.

| Model | | | | | | |
|---|---|---|---|---|---|---|
| configuration | Kernel size | Lag | Xcorr | FLOPs | #Parameters | Model size (Mb) |
| ConvGRU 4L64C | 1, 3 | 50 | 0.829 | 41.53G | 263K | 1.0 |
| ConvLSTM 4L64C | 1, 3 | 50 | 0.826 | 55.38G | 349K | 1.33 |
| ResNet 4B32C | 1, 3 | 50 | 0.650 | 112M | 35K | 0.14 |
| ResNet 4B128C | 1, 3 | 50 | 0.784 | 1.39G | 428K | 1.7 |
| ResNet 4B256C | 1, 3 | 50 | 0.796 | 5.30G | 1.65M | 6.3 |
| Sample and Hold | NA | NA | 0.501 | NA | NA | NA |

It can be seen in Table 7 that the ConvRNN framework in general outperforms the ResNet solutions described herein by approximately 0.03 on Xcorrelation. It is worth noting that the model complexity of ConvRNN solution is significantly higher than the one for ResNet. This is due to the fact that the recurrent computation of the states grows linearly with respect to the number of the input data lag, while ResNet grows in a constant fashion. Nevertheless, thanks to the recurrent model structure, which facilitates parameter sharing between each time step, the number of parameters for ConvRNN is significantly lower than ResNet. In telecommunication networks, due to hardware limitations, both the model storage size as well as the model's computational complexity should be taken into consideration. Therefore, reducing the complexity of the ConvRNN-based approaches is of great value.

Overall, ConvRNN-based approaches outperform the ResNet solutions discussed herein with a smaller number of parameters but higher model complexity.

While ConvLSTM-based models have shown promise in capturing spatiotemporal dependencies for channel prediction, their high computational complexity pose a significant barrier to practical deployment, particularly in resource-constrained scenarios such as high-speed user equipment (UEs) and edge devices. The intensive matrix operations in ConvLSTM networks lead to substantial computational overhead, resulting in increased latency, power consumption, and resource utilization. These limitations are particularly pronounced in dynamic environments where real-time processing may be important. To address these challenges, various embodiments of the present disclosure can reduce the complexity of channel prediction models while relatively preserving their predictive accuracy. Some embodiments leverage the so-called stacked ConvRNN method to improve computational efficiency.

One observation to be made is that for ConvRNN-based approaches, the major bottleneck of the computational complexity lies in the fact that the recurrent update function may need to be executed l times for each ConvRNN layer. This computational complexity grows linearly with respect to the input lag l, which as shown in the previously discussed example experiments, achieves great performance when set relatively large (40-50). Various embodiments of the present disclosure provide an approach to effectively reduce the number of recurrent computations while using the same number of input lag. Such approaches as described herein may be referred to as stacked ConvRNN methods. An element of these methods is to concatenate several consecutive input channels to form a single input tensor, therefore, based on the number of consecutive input channels concatenated, the number of recurrent computations can be significantly decreased.

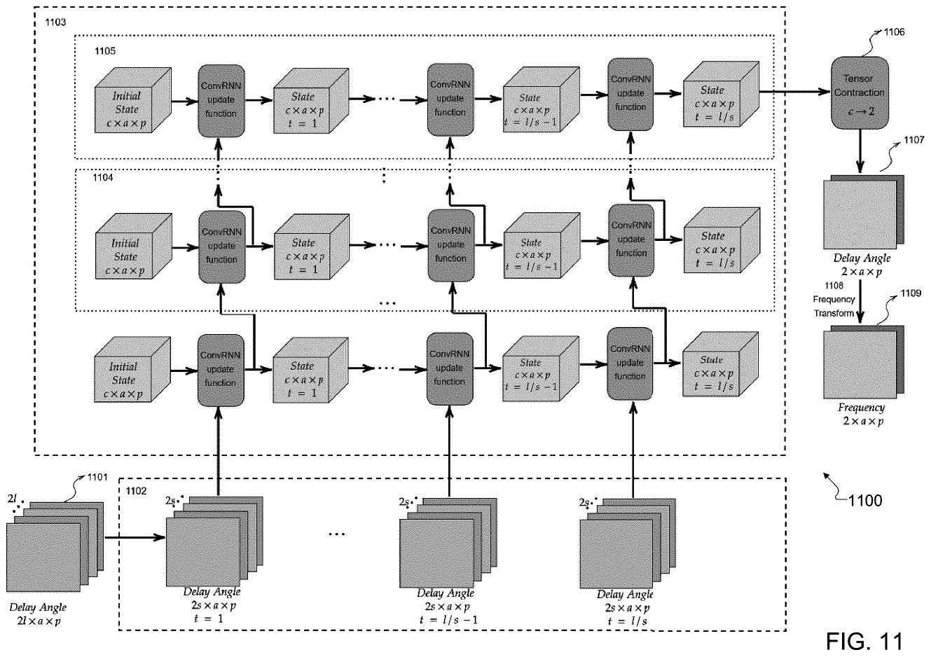

FIG. 11 illustrates an example model framework for multiple layers of stacked ConvRNN networks 1100 according to embodiments of the present disclosure. The embodiment of a model framework for multiple layers of stacked ConvRNN networks of FIG. 11 is for illustration only. Different embodiments of a model framework for multiple layers of stacked ConvRNN networks could be used without departing from the scope of this disclosure.

In the example of FIG. 11, without loss of generality, given an input sequence of channels H′₁, H′₂, . . . , H′ₗ, we have H′ᵢ∈ [symbol] , ∀i∈[l]. Then for an s-stacked ConvRNN, every s channels of consecutive TTIs is stacked. \tilde{H}′₁, . . . , \tilde{H}′_{l/s} denote to be s-stacked input data, where \tilde{H}′ₗ∈ [symbol] and (\tilde{H}′ᵢ)ⱼ=H′ᵢ₊ⱼ, ∀i∈[l] and j∈[s]. Then an s-stacked ConvRNN is a ConvRNN taking the s-stacked input data as input.

In the example of FIG. 11, notice that except for operation 1102, the remaining operations are very similar to the ones in FIG. 10, apart from a difference in the indices. In operation 1102, the s-stacked input data transformation is performed similarly as described regarding FIG. 10. It is assumed l can be divided by s with no remainder. Note that after the transformation, there are only l/s number of recurrent computations to perform, therefore significantly reducing the computational complexity of the ConvRNN-based approaches described herein.

Although FIG. 11 illustrates one example model framework for multiple layers of stacked ConvRNN networks 1100, various changes may be made to FIG. 11. For example, various changes to the number of layers could be made, etc. according to particular needs.

Table 8 shows the results of an experiment demonstrating the complexity reduction of the disclosed stacked ConvRNN method of FIG. 11. The example experiment of Table 8 used ConvGRU with 4 layers, 64 hidden channel size and (1, 3) kernel size. When the stack (i.e., s from FIG. 11) equals to 1, this is equivalent to the original version of the ConvGRU model.

TABLE 8
Example Experiment results for stacked ConvGRU

| Model | | | | | | | |
|---|---|---|---|---|---|---|---|
| configuration | Kernel size | Lag | Stack (s) | Xcorr | FLOPs | #Parameters | Model size (Mb) |
| ConvGRU 4L64C | 1, 3 | 50 | 1 | 0.829 | 41.53G | 263K | 1.0 |
| ConvGRU 4L64C | 1, 3 | 50 | 5 | 0.783 | 8.45G | 267K | 1.01 |
| ConvGRU 4L64C | 1, 3 | 50 | 10 | 0.774 | 4.31G | 273K | 1.04 |
| ConvGRU 4L64C | 1, 3 | 50 | 25 | 0.752 | 1.83G | 290K | 1.10 |
| Sample and Hold | NA | NA | NA | 0.501 | NA | NA | NA |

It can be seen that as s grows, the model complexity (i.e., FLOPs) drops significantly. On the other hand, the Xcorrelation performance did not decrease too much as the worst performance is at 0.752 with s=25, which is about 0.07 performance degradation, but the FLOPs is roughly 20 times less. We also notice a slight increase of the number of parameters as s increases. This is due to the fact that the input data at each time step has channel size of 2s instead of 2, therefore the size of the corresponding kernel tensor has been increased.

Various embodiments of the present disclosure can be used for channel estimation for 5G, 6G, and beyond wireless communication systems. The channel prediction solutions described herein can be used to improve channel prediction accuracy, and ultimately are beneficial for improving the reliability and capacity of wireless networks. These methods can also be extended to other use cases as described below, which are also useful for 5G, 6G, and beyond wireless communication systems.

Use case 1: Uplink SRS channel prediction is beneficial for a BS to perform efficient uplink scheduling. In particular, SRS channel prediction provides the BS information on the quality of the uplink channels from each UE beforehand, which includes signal strength, channel fading characteristics, and interference levels. This information helps in allocating radio resources (e.g. resource blocks) to users based on their expected channel quality, improving overall network efficiency as well as ensuring optimal utilization of the spectrum.

Use case 2: Uplink SRS channel prediction can be used to support downlink beamforming to throughput enhancement in a time-division duplexing (TDD) system. Based on uplink CSI obtained from SRS channel prediction and exploiting UL-DL channel reciprocity in a TDD system, the BS can adjust the beamforming weights and phase dynamically to maintain DL throughput, which is particularly beneficial for UEs with high mobility. Therefore, the disclosed channel prediction solutions are beneficial for enhancing downlink throughput performance.

In summary, by leveraging SRS channel prediction, cellular networks can provide efficient and reliable uplink and downlink transmission, beneficial for applications such as real-time video streaming, VoIP, or machine-to-machine communication.

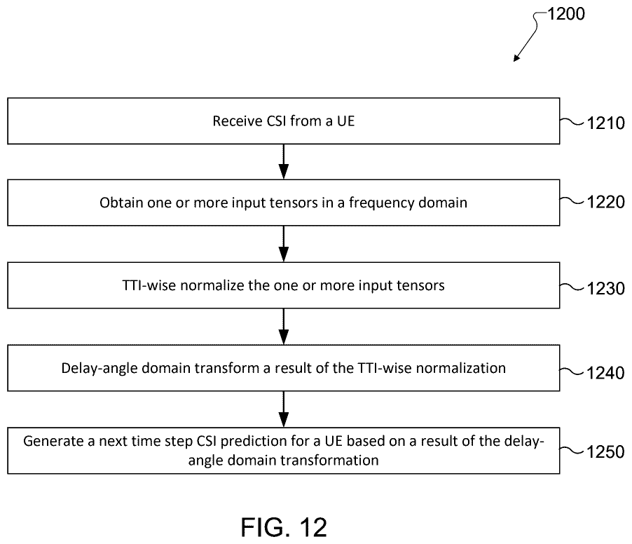

FIG. 12 illustrates an example method for AI-based high-speed CSI prediction with timing-offset and frequency-offset impairments 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for AI-based high-speed CSI prediction with timing-offset and frequency-offset impairments could be used without departing from the scope of this disclosure.

In the example of FIG. 12, method 1200 begins at step 1210. At step 1210, a BS (such as gNB 102 of FIG. 1) receives CSI from a UE (such as UE 116 of FIG. 1).

At step 1220, the BS obtains one or more input tensors in a frequency domain (for example, similar as described regarding operation 601 of FIG. 6), the one or more input tensors associated with the CSI received from the UE. In some embodiments, each of the one or more input tensors may be formed from a plurality of concatenated consecutive input channels (for example, similar as described regarding FIG. 10).

At step 1230, the BS TTI-wise normalizes the one or more input tensors (for example, similar as described regarding operations 602 through 605 of FIG. 6). In some embodiments, TTI-wise normalizing the one or more input tensors may include computing a TTI-wise average of the one or more input tensors (for example, similar as described regarding operation 602) and performing TTI-wise division on a result of the TTI-wise average (for example, similar as described regarding operation 604).

At step 1240, the BS delay-angle domain transforms a result of the TTI-wise normalization (for example, similar as described regarding operations 606 through 614 of FIG. 6). In some embodiments, delay-angle domain transforming the result of the TTI-wise normalization may include (i) delay-angle transforming the result of the TTI-wise normalization (for example, similar as described regarding operation 607), (ii) decomposing a result of the delay-angle transformation into real and imaginary parts (for example, similar as described regarding operation 611), (iii) obtaining a delay-angle prediction generated by a ML model based on the real and imaginary parts (for example, similar as described regarding operation 612), and (iv) converting the delay-angle prediction into the frequency domain (for example, similar as described regarding operation 613).

In some embodiments, the ML model may be configured to generate the delay-angle prediction using a ResNet-based neural network based on a spatial correlation of a channel and a temporal correlation of an input channel sequence (for example, similar as described regarding FIG. 7). In some embodiments, the ML model may be configured to generate the delay-angle prediction using at least one of a Conv-LSTM-based network and a Conv-GRU-based network based on a spatial correlation of one or more hidden states (for example, similar as described regarding FIGS. 9A and 9B).

At step 1250, the BS generates a next time step CSI prediction for the UE based on a result of the delay-angle domain transformation (for example, similar as described regarding operations 615 through 616 of FIG. 6). In some embodiments, generating the next time step CSI prediction for the UE based on a result of the delay-angle domain transformation may include decomposing a result of the frequency domain conversion into complex numbers (for example, similar as described regarding operation 615).

Although FIG. 12 illustrates one example method for AI-based high-speed CSI prediction with timing-offset and frequency-offset impairments 1200, various changes may be made to FIG. 12. For example, while shown as a series of steps, various steps in FIG. 12 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a transceiver configured to receive channel state information (CSI) from a user equipment (UE); and
a processor operably coupled to the transceiver, the processor configured to:
obtain one or more input tensors in a frequency domain, the one or more input tensors associated with the CSI received from the UE;
transition time interval (TTI)-wise normalize the one or more input tensors;
delay-angle domain transform a result of the TTI-wise normalization; and
generate a next time step CSI prediction for the UE based on a result of the delay-angle domain transformation.

2. The BS of claim 1, wherein to TTI-wise normalize the one or more input tensors, the processor is further configured to:
compute a TTI-wise average of the one or more input tensors; and
perform TTI-wise division on a result of the TTI-wise average.

3. The BS of claim 1, wherein to delay-angle domain transform the result of the TTI-wise normalization, the processor is further configured to:
delay-angle transform the result of the TTI-wise normalization;
decompose a result of the delay-angle transformation into real and imaginary parts;
obtain a delay-angle prediction generated by a machine learning (ML) model based on the real and imaginary parts; and
convert the delay-angle prediction into the frequency domain.

4. The BS of claim 3, wherein the ML model is configured to generate the delay-angle prediction using a residual neural networks (ResNet)-based neural network based on a spatial correlation of a channel and a temporal correlation of an input channel sequence.

5. The BS of claim 3, wherein ML model is configured to generate the delay-angle prediction using at least one of a convolutional long short-term memory (Conv-LSTM)-based network and a convolutional gated recurrent unit (ConvGRU)-based network based on a spatial correlation of one or more hidden states.

6. The BS of claim 3, wherein each of the one or more input tensors is formed from a plurality of concatenated consecutive input channels.

7. The BS of claim 3, wherein to generate the next time step CSI prediction for the UE based on a result of the delay-angle domain transformation, the processor is further configured to decompose a result of the frequency domain conversion into complex numbers.

8. A method of operating a base station (BS), the method comprising:
receiving channel state information (CSI) from a user equipment (UE);
obtaining one or more input tensors in a frequency domain, the one or more input tensors associated with the CSI received from the UE;
transition time interval (TTI)-wise normalizing the one or more input tensors;
delay-angle domain transforming a result of the TTI-wise normalization; and
generating a next time step CSI prediction for the UE based on a result of the delay-angle domain transformation.

9. The method of claim 8, wherein TTI-wise normalizing the one or more input tensors comprises:
computing a TTI-wise average of the one or more input tensors; and
performing TTI-wise division on a result of the TTI-wise average.

10. The method of claim 8, wherein delay-angle domain transforming the result of the TTI-wise normalization comprises:
delay-angle transforming the result of the TTI-wise normalization;
decomposing a result of the delay-angle transformation into real and imaginary parts;
obtaining a delay-angle prediction generated by a machine learning (ML) model based on the real and imaginary parts; and
converting the delay-angle prediction into the frequency domain.

11. The method of claim 10, wherein the ML model is configured to generate the delay-angle prediction using a residual neural networks (ResNet)-based neural network based on a spatial correlation of a channel and a temporal correlation of an input channel sequence.

12. The method of claim 10, wherein the ML model is configured to generate the delay-angle prediction using at least one of a convolutional long short-term memory (Conv-LSTM)-based network and a convolutional gated recurrent unit (ConvGRU)-based network based on a spatial correlation of one or more hidden states.

13. The method of claim 10, wherein each of the one or more input tensors is formed from a plurality of concatenated consecutive input channels.

14. The method of claim 10, wherein generating the next time step CSI prediction for the UE based on a result of the delay-angle domain transformation comprises decomposing a result of the frequency domain conversion into complex numbers.

15. A non-transitory computer readable medium embodying a computer program comprising program code that, when executed by a processor of a device, causes the device to:
receive channel state information (CSI) from a user equipment (UE);
obtain one or more input tensors in a frequency domain, the one or more input tensors associated with the CSI received from the UE;
transition time interval (TTI)-wise normalize the one or more input tensors;
delay-angle domain transform a result of the TTI-wise normalization; and
generate a next time step CSI prediction for the UE based on a result of the delay-angle domain transformation.

16. The non-transitory computer readable medium of claim 15, wherein to TTI-wise normalize the one or more input tensors, the program code, when executed by the processor of the device, causes the device to:
compute a TTI-wise average of the one or more input tensors; and
perform TTI-wise division on a result of the TTI-wise average.

17. The non-transitory computer readable medium of claim 15, wherein to delay-angle domain transform the result of the TTI-wise normalization, the program code, when executed by the processor of the device, causes the device to:
delay-angle transform the result of the TTI-wise normalization;
decompose a result of the delay-angle transformation into real and imaginary parts;
obtain a delay-angle prediction generated by a machine learning (ML) model based on the real and imaginary parts; and
convert the delay-angle prediction into the frequency domain.

18. The non-transitory computer readable medium of claim 17, wherein the ML model is configured to generate the delay-angle prediction using a residual neural networks (ResNet)-based neural network based on a spatial correlation of a channel and a temporal correlation of an input channel sequence.

19. The non-transitory computer readable medium of claim 17, wherein the ML model is configured to generate the delay-angle prediction using at least one of a convolutional long short-term memory (Conv-LSTM)-based network and a convolutional gated recurrent unit (ConvGRU)-based network based on a spatial correlation of one or more hidden states.

20. The non-transitory computer readable medium of claim 17, wherein each of the one or more input tensors is formed from a plurality of concatenated consecutive input channels.
